(19) United States
(12) Patent Application Publication
(10) Pub. No.: US 2012/0119489 A1
(43) Pub. Date: May 17, 2012

(54) TIGHTLY THREADED JOINT FOR OIL FIELD PIPES

(76) Inventors: Boris Yur'evich Shcherbakov, Taganrog Rostovskaya obl. (RU); Vladimir Petrovich Aldoxin, Taganrog Rostovskaya obl. (RU); Yurij Fyodorovich Emel'yanov, Taganrog Rostovskaya obl. (RU); Aleksej Sergeevich Myslevtcev, Taganrog Rostovskaya obl. (RU); Pavel Nikolaevich Sidorenko, Taganrog Rostovskaya obl. (RU)

(21) Appl. No.: 12/955,681

(22) Filed: Nov. 29, 2010

(30) Foreign Application Priority Data
Apr. 30, 2008 (RU) PCT/RU2008/000470

(51) Int. Cl. F16L 15/00

(52) U.S. Cl. 285/332

(57) ABSTRACT

The invention relates to building and operating vertical, controlled, directional and horizontal holes of oil and gas fields with difficult operating conditions, and can be used for process casing pipes. The inventive tightly threaded joint for oil field pipes comprises male and female pipes with a conical thread and stop and sealing surfaces. The stop surfaces are brought into contact by the end surface of the male pipe and the mating end surface of the female pipe. The conical thread configuration has a negative angle along a bearing face. The height of thread of the male pipe is less than the height of thread of the female pipe. The end surfaces are designed so that the area thereof is equal to or greater than 60% of the pipe body. The invention makes it possible to increase the operational reliability and effectiveness of the tight joint and to minimize ecological risks.

### CROSS-REFERENCE TO RELATED APPLICATION

This application claims the benefit of the priority filing date in PCT/RU2008/000470 and referenced in WIPO Publication WO/2009/134160. The earliest priority date claimed is Apr. 30, 2008.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The utility model pertains to the field of construction and operation of vertical, controlled, directional and horizontal wells in severe operating conditions, and can be used for process casings.

Known is a tightly threaded joint for oil field pipes comprising a male and a female pipe with taper threads, and tapered sealing and bearing surfaces. The pipes contact each other. The outside surface of the end section of the male pipe is in the form of a tapered surface with the taper angle toward the pipe axis and contacts the inside surface of the female pipe in the area between the taper thread and the pipe body. The mating surface of the male pipe is in the form of a tapered end surface with the taper angle in the taper thread of the pipe pointing toward the mating tapered end surface of the female pipe, in the area where the first tapered surface of the female pipe blends into the pipe body (FR patent 2798716, E16L 15/00, published Mar. 23, 2001).

This technical solution is used as the prototype for the claimed utility model.

Under severe operating conditions (compression and excess torque), deformations occur in said threaded joint that disrupt the tapered contact surfaces and result in unsealing the threaded joint.

The utility model is aimed at solving the technical problem of preventing the unsealing of a joint under severe operating conditions when building long horizontal wells, and where there is a need to additionally load and turn a string when lowering the joint in order to prevent oil and gas from entering the environment.

The achieved technical result is increased operational reliability and effectiveness of a tight joint under compression loads and torques, and minimized environmental risks when using the joint in a well.

This technical result is achieved in the form of a tightly threaded joint for oil field pipes that comprises a male pipe and a female pipe with taper threads, and bearing and sealing surfaces in which the pipes contact each other at the bearing end face and sealing surface of the male pipe and at the bearing end face and sealing surface of the female pipe. The bearing end faces and sealing surfaces have a taper thread profile that has a negative angle along the bearing end face. The height of the taper thread profile of the male pipe is lower than the height of the taper thread profile of the female pipe. The bearing end faces and sealing surfaces are made enlarged so that their area is equal to at least 60% of the pipe body.

### SUMMARY

The present invention is aimed at solving the technical problem of preventing the unsealing of a joint under severe operating conditions when building long horizontal wells, and where there is a need to additionally load and turn a string when lowering the joint in order to prevent oil and gas from entering the environment.

The achieved technical result is increased operational reliability and effectiveness of a tight joint under compression loads and torques, and minimized environmental risks when using the joint in a well.

This technical result is achieved in the form of a tightly threaded joint for oil field pipes that comprises a male pipe and a female pipe with taper threads, and bearing and sealing surfaces in which the pipes contact each other at the bearing end face and sealing surface of the male pipe and at the bearing end face and sealing surface of the female pipe. The bearing end faces and sealing surfaces have a taper thread profile that has a negative angle along the bearing end face. The height of the taper thread profile of the male pipe is lower than the height of the taper thread profile of the female pipe. The bearing end faces and sealing surfaces are made enlarged so that their area is equal to at least 60% of the pipe body.

### DRAWING

FIG. 1 shows a tightly threaded joint for oil field pipes comprising a male and female pipe.

FIG. 2 shows an exploded view of the male and female pipe, displaying a line parallel to the thread axis

FIG. 3 shows an exploded view of the male and female pipe, displaying the male pipe bearing end face and the female pipe bearing end face

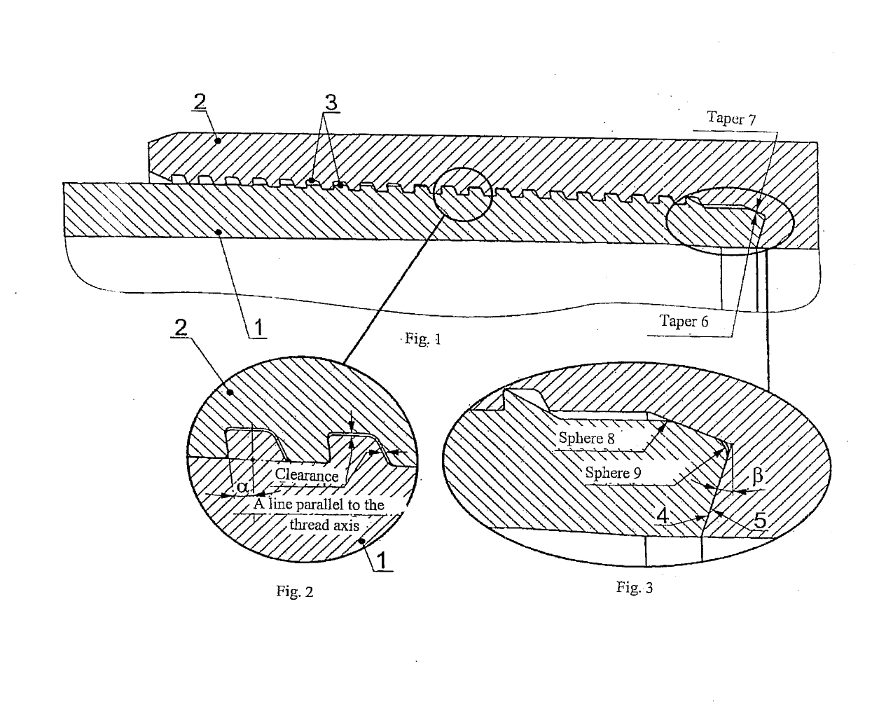

### DETAILED DESCRIPTION OF THE DRAWINGS

The joint comprises a male pipe 1 and a female pipe 2, which are engaged along a taper thread 3 (shown schematically).

The joint end section comprises the male pipe bearing end face 4 and the female pipe bearing end face 5. It also comprises a radial sealing zone with an outside tapered male sealing surface 6 and an inside tapered female sealing surface 7.

The female pipe bearing end face 4 and the male pipe bearing end face 5, as well as the male sealing surface 6 and female sealing surface 7, interface under stress and are elements of the main seal that ensures the joint's tightness.

The joint uses a taper thread. The thread profile has a negative angle α, and the height of the thread profile of the male pipe 1 is lower than the height of the thread profile of female pipe 2. The main function of the thread is to carry a tensile load, a bending load and, a partially compressed load.

The “metal-to-metal” type sealing that provides tightness is located in front of the thread of the male pipe 1 on the side of the thread cone generatrix. Due to the sealing, the threaded joint acquires properties of an oil-and-gas-tight joint that can work under compound loads in corrosive environments.

Enlarging the bearing faces ensures the operability and effectiveness of the tight joint under compression loads and torques.

The fact that the height of the male pipe thread is lower than the height of the female pipe thread improves joint threading and increases the joint's resistance to wear.

The tight joint for oil field pipes works as follows. When performing the operations of joint screwing and unscrewing, the male pipe 1 and the female pipe 2 first interface by means of a thread 3. While screwing, the male sealing surface 6 interfaces with the female sealing surface 7. Due to diametrical deformations of these surfaces, a “metal-to-metal” sealing is created. As the male pipe 1 and female pipe 2 keep moving, a forced contact of the male pipe bearing end face 4 and the female pipe bearing end face 5 is created. As a result, contact stresses develop on their surfaces. The magnitude of the contact stresses is within the limits of elastic deformation. All other conditions being equal, the level of contact stresses is determined by the size of the contact areas of the male pipe bearing end face 4 and the female pipe bearing end face 5.

Increased operational reliability of the joint is achieved by enlarging the mating areas of the male pipe bearing end face 4 and the female pipe bearing end face 5. This makes it possible to increase the screwing torque while keeping the contact stresses at the required level within the limits of elastic deformation. The end of the process of screwing together the male pipe 1 and the female pipe 2 is accompanied by the interaction of the male pipe bearing end face 4 and the female pipe bearing end face 5. The surfaces of the end faces are made in such a way that their area is equal to at least 60% of the pipe body. This ensures the operability of a tight joint under compression loads and torques. It also increases its operational reliability and prevents an unsealing of the joint, thereby preventing environmental pollution.

The utility model is commercially practicable and novel.

The advantages of the claimed threaded joint compared to the prototype are improved operational reliability and effectiveness of the threaded joint, increased joint strength (which makes the job of assembling and disassembling the joint easier), and minimal environmental risks when using the joint in a well.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

The following is claimed:

1. A tightly threaded joint of oil field pipes comprising a male pipe and a female pipe with taper threads and bearing and sealing surfaces, in which the pipes contact each other at a bearing end face and sealing surface of the male pipe and at a bearing end face and sealing surface of the female pipe, distinctive in that the bearing end faces and sealing surfaces have a taper thread profile that has a negative angle along the bearing end faces, the height of the taper thread profile of the male pipe is lower than the height of the taper thread profile of the female pipe, and the bearing end faces and sealing surfaces are made enlarged so that their area is equal to at least 60% of the body of the male pipe and the female pipe, respectively.
